(19) United States
(12) Patent Application Publication
(10) Pub. No.: US 2024/0327567 A1
(43) Pub. Date: Oct. 3, 2024

(54) Low Temperature Curable One Component Epoxy Compositions containing Resin-Blocked Urea Curatives

(71) Applicant: EVONIK OPERATIONS GMBH, Essen (DE)

(72) Inventors: Shafiq Fazel, Allentown, PA (US); Emmanouil Roumpelakis, Recklinghausen (DE); Gauri Sankar Lal, Whitehall, PA (US); John Hartmann, Medford, NJ (US); Douglas M La Comare, Northampton, PA (US)

(73) Assignee: EVONIK OPERATIONS GMBH, Essen (DE)

(21) Appl. No.: 18/129,605

(22) Filed: Mar. 31, 2023

(51) Int. Cl. C08G 59/40; C08G 8/10; C08G 59/42; C08G 59/62; C08L 63/04

(52) U.S. Cl. CPC C08G 59/4021; C08G 8/10; C08G 59/4261; C08G 59/621; C08L 63/04

(57) ABSTRACT

The present disclosure provides for latent curing accelerators as well as compositions containing such a latent curing accelerator with a substance to be cured (e.g., an epoxy resin). The latent curing accelerators comprise a urea compound and an encapsulant system having a polyphenol resin and/or at least one additional excipient. Methods of making and use are further provided.

### BACKGROUND OF THE INVENTION

Epoxy based adhesives are used in various applications in the automotive, electronics, aerospace and general industries. They are increasingly replacing conventional bonding systems such as soldering, welding, rivets, nails, screws and bolts because of the benefits they provide over these systems. Some of these benefits include bonding similar and dissimilar substrates without damaging them, better distribution of stress over wide area, better fatigue resistance and noise and vibration resistance.

Compositions comprising an epoxy resin and a curing agent (hardener) have been known for decades. Many curing agents are reactive with the epoxy resin at room temperature and therefore need to be mixed just prior to use. Others known as latent hardeners are stable in admixture with the epoxy resin at ambient temperature and effect hardening only when heated to elevated temperature. Some compounds also act as accelerators of the latent curing agent, dicyandiamide (DICY) or an acid anhydride and effect cure of epoxy resins at elevated temperatures. A one-component epoxy based adhesive system is preferred over a two-component system because it eliminates the mixing step, the required time to apply it, the cooling during storage and shipping associated with the two-component system.

U.S. Pat. No. 4,866,133 describes the use of a solid solution of a polymeric polyhydric phenol with polyamines for curing epoxy resins. In U.S. Pat. No. 4,689,390 a latent curing agent was prepared by reacting a diamine bearing a tertiary amine and a primary or secondary amino group with a poly-epoxy compound and a phenolic resin or phenolic compounds. A solution of a tertiary polyamine in a poly-phenolic resin made from bisphenolic A diglycidyl ether and a polyamino secondary amine was described as a latent epoxy curing agent in U.S. patent application Ser. No. 13/075,403. U.S. Pat. No. 7,910,667 describes a polyphenolic resin solution of a polyurea derivative of a tertiary polyamine which has been used as a latent epoxy curing agent. U.S. Pat. No. 9,546,243 describes polyphenolic resin solutions of certain classes of amines which have been used as a sole latent epoxy curing agent as well as DICY accelerators. Lastly, U.S. Pat. No. 9,000,120 reports a heat-activatable DICY accelerator that consists of a tertiary amine and a Novolac resin.

The present invention relates to latent curing agents and accelerators for epoxy resins including 100% solids epoxy compositions and water-based compositions, especially one-component 100% solids epoxy compositions. “Latent” curing agents are those curatives that in a formulated epoxy system remain inactive under normal ambient conditions but react readily with the epoxy resin at elevated temperatures. “Accelerators” are those materials that accelerate the reaction between the epoxy resin and the curing agent. “One component” epoxy compositions are typically a blend of an epoxy resin, a curing agent and optionally an accelerator as well as additives and fillers. “100% solids” means the epoxy composition contains no water or organic solvent. There is a need for latent epoxy curing agents or accelerators which exhibit prolonged storage stability at ambient temperature and cure rapidly at >100° C.

### SUMMARY OF THE INVENTION

Accordingly, provided herein are epoxy curing agents and related compositions that allow for lower curing temperatures without compromising the latency of the epoxy resin composition.

We have found that it is possible to obtain epoxy curing agents having improved storage stability and low cure temperature through solutions containing encapsulant systems comprising a urea compound in combination with polyphenolic resins and/or one or more monomeric or polymeric compounds, either of which may be functionalized with a moiety capable of interacting with tertiary amines, e.g., acidic substituents such as OH, COOH, SO₃OH, PO(OH)₃, and PO(OH)₂. Non-functional compounds or polymers do not bear these functional groups and would not interact with tertiary amines.

In a first aspect, the present disclosure is directed to a latent curing accelerator composition [Composition 1] comprising:
an encapsulant system comprising:
   a urea compound,
   a polyphenol resin, and
   an additional excipient selected from a functional component and/or a non-functional component.

In some embodiments, Composition 1 is defined as follows:
1.1 Composition 1, wherein the urea compound comprises a reaction product of an isocyanate and an alkylated polyalkylenepolyamine.
1.2 Composition 1 or 1.1, wherein the isocyanate is selected from the group consisting of aliphatic isocyanates, cycloaliphatic isocyanates and aromatic isocyanates.
1.3 Any of the preceding Compositions, wherein the isocyanate is selected from the group consisting of phenylisocyanate, toluene diisocyanate (TDI), methylene diphenyl diisocyanate (MDI) and polymeric methylene diphenyl diisocyanate.
1.4 Any of the preceding Compositions, wherein the alkylated polyalkylenepolyamine has at least one primary or secondary amine and at least two tertiary amines of the formula (A):

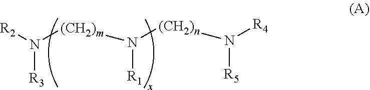

where R₁, R₂, R₃, R₄ and R₅ are independently hydrogen, methyl or ethyl; m and n are independently integers from 1 to 6 and; X is an integer from 1 to 10.
1.5 The preceding Composition, wherein R₁ is hydrogen or methyl; R₂ and R₄ are methyl; and R₃ and R₅ are hydrogen or methyl.
1.6 Any of the preceding Compositions, wherein the alkylated polyalkylenepolyamine is N′-(3-dimethylaminopropyl)-N,N-dimethylpropane-1,3-diamine (Polycat® 15) or poly-N-methyl-azetidine.
1.7 Composition 1, wherein the urea compound comprises a reaction product of a primary amine bearing tertiary amine functionality and urea (carbamide).
1.8 The preceding Composition, wherein the urea compound is 1,3-bis[3-(dimethylamino)propyl]urea (DABCO NE1082).
1.9 Any of the preceding Compositions, wherein the urea compound is present in an amount of about 5 wt. % to about 75 wt. %, based on the total weight of the composition.
1.10 Any of the preceding Compositions, wherein the polyphenol resin is a phenolic resin of the formula (B):

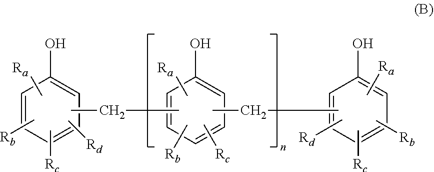

where Rₐ, R_{b}, R_{c}, and R_{d} are each independently a hydrogen or a branched or unbranched C₁-C₁₇ alkyl group, and n is an integer from 0 to 50.
1.11 Any of the preceding Compositions, wherein the polyphenol resin comprises or consists of a phenolic novolac resin.
1.12 Any of the preceding Compositions, wherein the polyphenol resin is a phenol-formaldehyde resin.
1.13 Any of the preceding Compositions, wherein the polyphenol resin is Alnovol PN320.
1.14 Any of the preceding Compositions, wherein the polyphenol resin is present in an amount of about 5 wt. % to about 75 wt. %, based on the total weight of the composition.
1.15 Any of the preceding Compositions, wherein the additional excipient is a functional compound comprises one or more of (a) a monomeric carboxylic acid, sulfonic acid, phosphonic acid, phosphoric acid, or boric acid; (b) a polyester resin; (c) an acrylic resin; (d) a polyether resin; (e) a polybutadiene resin; and (f) a polyamide resin.
1.16 Any of the preceding Compositions, wherein the additional excipient is present in an amount of about 5 wt. % to about 75 wt. %, based on the total weight of the composition.
1.17 Any of the preceding Compositions, wherein the additional excipient comprises or consists of a functional compound present in an amount of about 5 wt. % to about 75 wt. %, based on the total weight of the composition.
1.18 Any of the preceding Compositions, wherein the additional excipient is a monomeric carboxylic acid, sulfonic acid, phosphonic acid, phosphoric acid, or boric acid.
1.19 Any of the preceding Compositions, wherein the additional excipient comprises or consists of a monomeric carboxylic acid.
1.20 Any of the preceding Compositions, wherein the additional excipient comprises or consists of a monomeric sulfonic acid.
1.21 Any of the preceding Compositions, wherein the additional excipient comprises or consists of a monomeric phosphonic acid.
1.22 Any of the preceding Compositions, wherein the additional excipient comprises or consists of a monomeric phosphoric acid.
1.23 Any of the preceding Compositions, wherein the additional excipient comprises or consists of a monomeric boric acid.
1.24 Any of the preceding Compositions, wherein the additional excipient comprises or a consists of a polyester resin.
1.25 The preceding Composition, wherein the polyester resin has a structure according to the following formula:

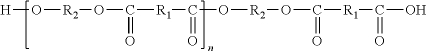

where R₁ is saturated or unsaturated alkyl or aryl,
   R₂ is C₁₋₁₀alkyl or C₁₋₁₀cycloalkyl, and
   n is 0-20.
1.26 Any of the preceding Compositions, wherein the polyester resin is a polycondensation product of a polyalcohol and a polycarboxylic acid, e.g., a polycondensation product of polyalcohols and polycarboxylic acids, e.g., a polycondensation product of dicarboxylic acids, di-alcohols (diols) and trifunctional alcohols or carboxylic acids.
1.27 Any of the preceding Compositions, wherein the additional excipient comprises or a consists of an acrylic resin.
1.28 The preceding Composition, wherein the acrylic resin has a structure according to the following formula:

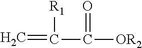

where R₁ is H or CH₃; and
R₂ is C₁₋₃ alkyl.
1.29 Any of the preceding Compositions, wherein the acrylic resin is formed by free radical polymerization of acrylic and vinyl monomers with unsaturated monomers containing hydroxy or carboxy groups.
1.30 Any of the preceding Compositions, wherein the additional excipient comprises or consists of a polyether resin.
1.31 Any of the preceding Compositions, wherein the additional excipient is a polyalkylene glycol.
1.32 The preceding Composition, wherein the polyalkylene glycol has a molecular weight between about 1,000 D and about 100,000 D.
1.33 The preceding Composition, wherein the polyalkylene glycol has a molecular weight between about 1,500 D and about 35,000 D.
1.34 The preceding Composition, wherein the polyalkylene glycol has a molecular weight between about 1,500 D and about 10,000 D.
1.35 Any of the preceding Compositions, wherein the additional excipient comprises or consists of a polybutadiene resin.
1.36 The preceding Composition, wherein the polybutadiene resin is a carboxylated polybutadiene.
1.37 The preceding Composition, wherein the carboxylated polybutadiene has a polybutadiene backbone microstructure consisting of a combination of vinyl 1,2-linkage, trans 1,4-linkage and cis 1,4-linkage.
1.38 Any of Compositions 1.36-1.37, wherein the carboxylated polybutadiene has an average molecular weight between about 500 D and about 10,000 D.
1.39 Any of Compositions 1.36-1.38, wherein the carboxylated polybutadiene has a molecular weight between about 1,000 D and about 7,000 D.
1.40 Any of Compositions 1.36-1.39, wherein the carboxylated polybutadiene has a molecular structure that is composed of 70 to 90% of cis double bonds, 10 to 30% of trans double bonds and 0 to 3% of vinyl double bonds.
1.41 Any of Compositions 1.36-1.40, wherein the carboxylated polybutadiene is a maleic anhydride adduct of cis-1.4-polybutadiene (e.g., low molecular weight cis-1.4-polybutadiene), optionally having succinic anhydride pendant groups randomly distributed the polymer chain.
1.42 Any of the preceding Compositions, wherein the additional excipient comprises or consists of a polyamide resin.
1.43 The preceding Composition, wherein the polyamide resin is a nylon (e.g., nylon-6, nylon 6-6, a copolymer of nylon-6 and nylon 6-6, nylon-9, nylon-10, nylon-11, nylon-12, nylon 6-10), aromatic polyamides, elastomeric polyamides, and mixtures thereof.
1.44 Any of Compositions 1.42-1.43, wherein the polyamide resin is an acid functional thermoplastic polyamide.
1.45 Any of the preceding Compositions, wherein the additional excipient is a non-functional component is a polymeric compound selected from acrylates, polybutadienes, polyamides, ketone-aldehyde condensation resins, polyimides, styrene-butadiene resins, copolymers of olefins, and combination thereof.
1.46 Any of the preceding Compositions, wherein the additional excipient comprises or consists of a non-functional compound present in an amount of about 5 wt. % to about 75 wt. %, based on the total weight of the composition.
1.47 Any of the preceding Compositions, wherein the composition has an onset temperature of about 135° C. to about 142° C.
1.48 Any of the preceding Compositions, wherein the composition has a viscosity of about 19,000 cP to about 21,000 cP.
1.49 Any of the preceding Compositions, wherein the composition does not gel after 4 weeks under accelerated aging conditions (i.e., storage for 4 weeks at 40° C.).
1.50 Any of the preceding Compositions, wherein the composition has a lap shear greater than 700 psi.
1.51 Any of the preceding Compositions, wherein the additional excipient is an acrylic resin and the composition has a lap shear greater than 700 psi.
1.52 Any of the preceding Compositions, wherein the composition has an adhesive strength as determined by a T-peel test between about 60 pli and 120 pli.
1.53 Any of the preceding Compositions, wherein the additional excipient is an acrylic resin and the composition has an adhesive strength as determined by a T-peel test between about 60 pli and 120 pli.
1.54 Any of the preceding Compositions, wherein the composition is in liquid or solid powder form.
1.55 Any of the preceding Compositions, wherein the composition is in the form of an aqueous solution.
1.56 Any of the preceding Compositions, further comprising one or more of a wetting agent, filler, defoamer, and rheology modifier.
1.57 Any of the preceding Compositions, wherein the composition is a latent curing agent (e.g., the sole latent curing agent) for an epoxy resin.

In a second aspect, the present disclosure is directed to a latent curing accelerator composition [Composition 2] comprising:
an encapsulant system comprising:
   a urea compound, and
   an additional excipient selected from a functional component and/or a non-functional component.

In some embodiments, Composition 2 is defined as follows:
2.1 Composition 2, wherein the wherein the urea compound comprises a reaction product of an isocyanate and an alkylated polyalkylenepolyamine.
2.2 Composition 2 or 2.1, wherein the isocyanate is selected from the group consisting of aliphatic isocyanates, cycloaliphatic isocyanates and aromatic isocyanates.
2.3 Any of the preceding Compositions, wherein the isocyanate is selected from the group consisting of phenylisocyanate, toluene diisocyanate (TDI), methylene diphenyl diisocyanate (MDI) and polymeric methylene diphenyl diisocyanate.
2.4 Any of the preceding Compositions, wherein the alkylated polyalkylenepolyamine has at least one primary or secondary amine and at least two tertiary amines of the formula (A):

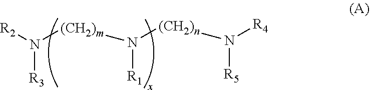

where R₁, R₂, R₃, R₄ and R₅ are independently hydrogen, methyl or ethyl; m and n are independently integers from 1 to 6 and; X is an integer from 1 to 10.
2.5 The preceding Composition, wherein R₁ is hydrogen or methyl; R₂ and R₄ are methyl; and R₃ and R₅ are hydrogen or methyl.
2.6 Any of the preceding Compositions, wherein the alkylated polyalkylenepolyamine is N′-(3-dimethylaminopropyl)-N,N-dimethylpropane-1,3-diamine (Polycat® 15) or poly-N-methyl-azetidine.
2.7 Composition 2, wherein the urea compound comprises a reaction product of a primary amine bearing tertiary amine functionality and urea (carbamide).
2.8 The preceding Composition, wherein the urea compound is 1,3-bis[3-(dimethylamino)propyl]urea (DABCO NE1082).
2.9 Any of the preceding Compositions, wherein the urea compound is present in an amount of about 5 wt. % to about 75 wt. %, based on the total weight of the composition.
2.10 Any of the preceding Compositions, wherein the additional excipient is a functional compound comprises one or more of (a) a monomeric carboxylic acid, sulfonic acid, phosphonic acid, phosphoric acid, or boric acid; (b) a polyester resin; (c) an acrylic resin; (d) a polyether resin; (e) a polybutadiene resin; and (f) a polyamide resin.
2.11 Any of the preceding Compositions, wherein the additional excipient is present in an amount of about 5 wt. % to about 75 wt. %, based on the total weight of the composition.
2.12 Any of the preceding Compositions, wherein the additional excipient comprises or consists of a functional compound present in an amount of about 5 wt. % to about 75 wt. %, based on the total weight of the composition.
2.13 Any of the preceding Compositions, wherein the additional excipient is a monomeric carboxylic acid, sulfonic acid, phosphonic acid, phosphoric acid, or boric acid.
2.14 Any of the preceding Compositions, wherein the additional excipient comprises or consists of a monomeric carboxylic acid.
2.15 Any of the preceding Compositions, wherein the additional excipient comprises or consists of a monomeric sulfonic acid.
2.16 Any of the preceding Compositions, wherein the additional excipient comprises or consists of a monomeric phosphonic acid.
2.17 Any of the preceding Compositions, wherein the additional excipient comprises or consists of a monomeric phosphoric acid.
2.18 Any of the preceding Compositions, wherein the additional excipient comprises or consists of a monomeric boric acid.
2.19 Any of the preceding Compositions, wherein the additional excipient comprises or a consists of a polyester resin.
2.20 The preceding Composition, wherein the polyester resin has a structure according to the following formula:

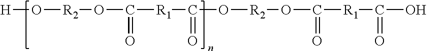

where R₁ is saturated or unsaturated alkyl or aryl,
   R₂ is C₁₋₁₀ alkyl or C₁₋₁₀ cycloalkyl, and
   n is 0-20.
2.21 Any of the preceding Compositions, wherein the polyester resin is a polycondensation product of a polyalcohol and a polycarboxylic acid, e.g., a polycondensation product of polyalcohols and polycarboxylic acids, e.g., a polycondensation product of dicarboxylic acids, di-alcohols (diols) and trifunctional alcohols or carboxylic acids.
2.22 Any of the preceding Compositions, wherein the additional excipient comprises or a consists of an acrylic resin.
2.23 The preceding Composition, wherein the acrylic resin has a structure according to the following formula:

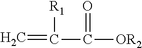

where R₁ is H or CH3; and
   R₂ is C₁₋₃ alkyl.
2.24 Any of the preceding Compositions, wherein the acrylic resin is formed by free radical polymerization of acrylic and vinyl monomers with unsaturated monomers containing hydroxy or carboxy groups.
2.25 Any of the preceding Compositions, wherein the additional excipient comprises or consists of a polyether resin.
2.26 Any of the preceding Compositions, wherein the additional excipient is a polyalkylene glycol.
2.27 The preceding Composition, wherein the polyalkylene glycol has a molecular weight between about 1,000 D and about 100,000 D.
2.28 The preceding Composition, wherein the polyalkylene glycol has a molecular weight between about 1,500 D and about 35,000 D.
2.29 The preceding Composition, wherein the polyalkylene glycol has a molecular weight between about 1,500 D and about 10,000 D.
2.30 Any of the preceding Compositions, wherein the additional excipient comprises or consists of a polybutadiene resin.
2.31 The preceding Composition, wherein the polybutadiene resin is a carboxylated polybutadiene.
2.32 The preceding Composition, wherein the carboxylated polybutadiene has a polybutadiene backbone microstructure consisting of a combination of vinyl 1,2-linkage, trans 1,4-linkage and cis 1,4-linkage.
2.33 Any of Compositions 2.31-2.32, wherein the carboxylated polybutadiene has an average molecular weight between about 500 D and about 10,000 D.
2.34 Any of Compositions 2.31-2.33, wherein the carboxylated polybutadiene has a molecular weight between about 1,000 D and about 7,000 D.
2.35 Any of Compositions 2.31-2.34, wherein the carboxylated polybutadiene has a molecular structure that is composed of 70 to 90% of cis double bonds, 10 to 30% of trans double bonds and 0 to 3% of vinyl double bonds.
2.36 Any of Compositions 2.31-2.35, wherein the carboxylated polybutadiene is a maleic anhydride adduct of cis-1.4-polybutadiene (e.g., low molecular weight cis-1.4-polybutadiene), optionally having succinic anhydride pendant groups randomly distributed the polymer chain.
2.37 Any of the preceding Compositions, wherein the additional excipient comprises or consists of a polyamide resin.
2.38 The preceding Composition, wherein the polyamide resin is a nylon (e.g., nylon-6, nylon 6-6, a copolymer of nylon-6 and nylon 6-6, nylon-9, nylon-10, nylon-11, nylon-12, nylon 6-10), aromatic polyamides, elastomeric polyamides, and mixtures thereof.
2.39 Any of Compositions 2.37-2.38, wherein the polyamide resin is an acid functional thermoplastic polyamide.
2.40 Any of the preceding Compositions, wherein the additional excipient is a non-functional component is a polymeric compound selected from acrylates, polybutadienes, polyamides, ketone-aldehyde condensation resins, polyimides, styrene-butadiene resins, copolymers of olefins, and combination thereof.
2.41 Any of the preceding Compositions, wherein the additional excipient comprises or consists of a non-functional compound present in an amount of about 5 wt. % to about 75 wt. %, based on the total weight of the composition.
2.42 Any of the preceding Compositions, wherein the composition does not gel after 4 weeks under accelerated aging conditions (i.e., storage for 4 weeks at 40° C.).
2.43 Any of the preceding Compositions, wherein the composition is in liquid or solid powder form.
2.44 Any of the preceding Compositions, wherein the composition is in the form of an aqueous solution.
2.45 Any of the preceding Compositions, further comprising one or more of a wetting agent, filler, defoamer, and rheology modifier.
2.46 Any of the preceding Compositions, wherein the composition is a latent curing agent (e.g., the sole latent curing agent) for an epoxy resin.

In a third aspect, the present disclosure is directed to a curable epoxy system [System 1] comprising:
a latent curing accelerator composition (i.e., Composition 1, et seq. or Composition 2, et seq.); and
an epoxy resin.

In some embodiments, System 1 is defined as follows:
1.1 System 1, wherein the latent curing accelerator composition is according to any of Composition 1, et seq.
1.2 System 1, wherein the latent curing accelerator composition is according to any of Composition 2, et seq.
1.3 Any of the preceding Systems, wherein the epoxy is a glycidyl ether, polyhydric phenol, or cycloaliphatic epoxide (including diepoxides of cycloaliphatic esters of dicarboxylic acids).
1.4 Any of the preceding Systems, wherein the epoxy is a polymer according to the following formula:

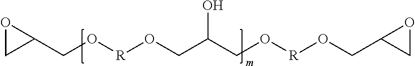

where m is an integer and R is a divalent hydrocarbon radical of a dihydric phenol.
1.5 Any of the preceding Systems, wherein the system has an onset temperature of about 135° C. to about 142° C.
1.6 Any of the preceding Systems, wherein the system has a viscosity of about 19,000 cP to about 21,000 cP.
1.7 Any of the preceding Systems, wherein the system does not gel after 4 weeks under accelerated aging conditions (i.e., storage for 4 weeks at 40° C.).
1.8 Any of the preceding Systems, wherein the system gives a lap shear greater than 700 psi.
1.9 Any of the preceding Systems, wherein the additional excipient in the latent accelerator composition is an acrylic resin and the system gives a lap shear greater than 700 psi.
1.10 Any of the preceding Systems, wherein the system gives an adhesive strength as determined by a T-peel test between about 60 pli and 120 pli.
1.11 Any of the preceding Systems, wherein the additional excipient in the latent accelerator composition is an acrylic resin and the system gives an adhesive strength as determined by a T-peel test between about 60 pli and 120 pli.
1.12 Any of the preceding Systems, further comprising one or more of a wetting agent, filler, defoamer, and rheology modifier.
1.13 Any of the preceding Systems, wherein the latent accelerator composition is a latent curing agent (e.g., the sole latent curing agent) for an epoxy resin.
1.14 Any of the preceding Systems, further comprising DICY.

In a fourth aspect, the present disclosure is directed to a method for curing a substance through use of a latent curing accelerator composition [Method 1], the method comprising the step of combining the substance with the latent curing accelerator composition and heating the resulting mixture.

In some embodiments, Method 1 is defined as follows:
1.1 Method 1, wherein the substance is an epoxy resin.
1.2 Method 1 or 1.1, wherein the latent curing accelerator composition is according to Composition 1, et seq.
1.3 Method 1 or 1.1, wherein the latent curing accelerator composition is according to Composition 2, et seq.
1.4 Any of the preceding Methods, wherein the mixture containing the substance with the latent curing accelerator is heated to a temperature of about 135° C. to about 142° C.
1.5 Any of the preceding Methods, wherein the latent curing accelerator composition is formed by blending the encapsulant system under nitrogen atmosphere and heating to a temperature of 120° C. to 180° C.
1.6 Any of the preceding Methods, wherein the composition is a latent curing agent (e.g., the sole latent curing agent) for an epoxy resin.
1.7 Any of the preceding Methods, wherein the composition is used as an accelerator for a curing agent such as DICY or an acid anhydride for epoxy resin.
1.8 Any of the preceding Methods, wherein the composition is used as a latent curing accelerator for structural adhesives and composites, electrical potting and encapsulation, compositions for reinforcement and/or dampening, cured in place pipe, crash durable adhesives, filament winding, transfer molding powders, prepreg with solid or liquid epoxy, sheet molding compound, coatings on concrete, wood, metal etc., resin transfer molding, and/or EV battery pack adhesives.

The disclosure further provides a latent curing accelerator composition for use in a method for curing a substance, e.g., for use in any of Methods 1, et seq.

The disclosure further provides the use of a latent curing accelerator composition in the manufacture of a curable formulation comprising a substance and the latent curing accelerator composition, e.g., for use in any of Methods 1, et seq.

Every aspect and every embodiment of the invention as disclosed herein is meant to be combined with all the other disclosed aspects and embodiments of the invention individually and in all possible combinations thereof.

### DETAILED DESCRIPTION OF THE INVENTION

The present disclosure provides for latent curing accelerators as well as compositions containing such a latent curing accelerator with a substance to be cured (e.g., an epoxy resin). Methods of making and use are further provided.

The invention relates to certain urea-(resin 1:resin 2) compound reaction product compositions and their use as curing agents or as accelerators for latent curing agents, such as dicyandiamide, Mercaptan or acid anhydride, in curing epoxy resin compositions.

In one embodiment, the latent curing agent and the accelerator for latent curing agents are a composition which is the reaction product of (a) a urea compound and (b) a phenolic resin (resin 1) combined with (c) another type of functional or non-functional monomeric compound or polymeric resin (resin 2).

In another embodiment, the latent curing agent and the accelerator for latent curing agents are a composition which is the reaction product of (a) a urea compound and (c) another type of functional or non-functional monomeric compound or polymeric resin (resin 2).

### Urea Compound

The latent curing accelerators of the present disclosure comprise an encapsulant system, which includes as a principal component a urea compound.

In one preferred embodiment of the invention, the urea compound (a) is the reaction product of an isocyanate and an alkylated polyalkylenepolyamine having at least one primary or secondary amine and at least two tertiary amines of the formula (A):

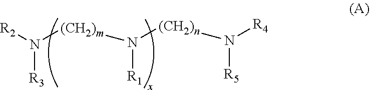

where R₁, R₂, R₃, R₄ and R₅ independently represent hydrogen, methyl or ethyl; m and n are independently integers from 1 to 6 and; X is an integer from 1 to 10. In another preferred embodiment, R₁ represents hydrogen or methyl; R₂ and R₄ represent methyl; and R₃ and R₅ represent hydrogen or methyl, i.e., a methylated polyalkylenepolyamine.

For other preferred embodiments of each of the foregoing aspects and embodiments, the R₁-R₅ substituents are selected individually or in any combination provided the amine molecule has one primary or secondary amine and at least two tertiary amines.

Yet in other preferred embodiments of each of the foregoing aspects and embodiments, integers m, n and X are selected individually or in any combination of each other over the ranges stated above for each, with certain aspects of m and n being 2 or 3 and X being 1 to 7; m and n being 3 and X being 1; and m and n being 3 and X being 1 to 7.

Preferred isocyanates useful for reacting with the polyalkylenepolyamine are any of the aliphatic isocyanates, cycloaliphatic isocyanates and aromatic isocyanates in which the isocyanate functionality —NCO is bonded directly to the aromatic ring. Preferred isocyanates include phenylisocyanate, toluene diisocyanate (TDI) including 2,4-TDI, 2,6-TDI and 2,4/2,6-TDI, methylene diphenyl diisocyanate (MDI) including its polymethylene polyphenylene poly(isocyanate) polymeric homologs, i.e., polymeric MDI.

The urea compounds of the invention can be prepared by reactions well known to a chemist and are reported in the literature such as in Jerry March, Advanced Organic Chemistry, Wiley-Interscience, Fourth Edition, page 1299. In one embodiment, the isocyanate and the polyamine are reacted in a polyamine:isocyanate equivalents ratio of 1:1 for polyamines having one primary or secondary amine and isocyanates having one NCO group, 1:2 for polyamines having a total of two primary and/or secondary amines and isocyanates having one NCO group, 2:1 for polyamines having one primary or secondary amine and isocyanates having two NCO groups; optionally in a solvent such as toluene at elevated temperatures of 50-100° C. under an inert atmosphere at ambient pressure. In addition, the urea compounds are available commercially from Sigma Aldrich, Evonik Industries AG, Huntsman, and AlChem.

In one preferred embodiment of the invention, preferred polyalkylenepolyamines for reacting with the isocyanate include 3,3′-iminobis(N,N-dimethylpropylamine), also known as N′-(3-dimethylaminopropyl)-N,N-dimethylpropane-1,3-diamine and available as Polycat® 15 catalyst from Evonik Industries AG and poly-N-methyl-azetidine, the preparation and structures of which are taught in U.S. 2008-0194776-A1 the disclosure of which is incorporated by reference herein. This embodiment is meant to be combined with all other disclosed aspects and embodiments of the invention.

In another preferred embodiment of this invention, the urea compound (a) is the reaction product of a primary amine bearing tertiary amine functionality and urea (carbamide). For example, 1,3-bis[3-(dimethylamino)propyl]urea (DABCO NE1082) is one example of this type of urea compound and is available from Evonik Corporation.

### Polyphenolic Resins

In various embodiments, the encapsulant system of the present disclosure further includes a phenolic resin. The chemical structure of such phenolic resin is represented by formula (B) below:

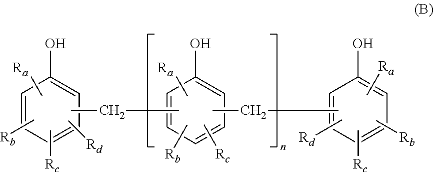

where Rₐ, R_{b}, R_{c}, and R_{d} are each independently a hydrogen or a branched or unbranched C₁-C₁₇ alkyl group, and n is an integer from 0 to 50. In a preferred embodiment, Rₐ, R_{b}, R_{c}, and R_{d} are each independently a hydrogen or a branched or unbranched C₁-C₁₀ alkyl group, and n is an integer from 1 to 20. In these preferred embodiments, preferred alkyl groups include methyl, ethyl, n-propyl, isopropyl, and all the isomers of butyl, pentyl, hexyl, octyl, including 2-ethyhexyl, decyl, and dodecyl. In another preferred embodiment of the phenolic resin, Rₐ-R_{d} are each hydrogen. For other preferred embodiments of each of the foregoing aspects and embodiments, the Rₐ-R_{d} substituents are selected individually or in any combination.

In a preferred embodiment of the invention the phenolic resin is a Novolac resin, a compound formed by the condensation of a phenol with an aldehyde, especially formaldehyde. Novolac resins are the reaction product of a mono or dialdehyde, most usually formaldehyde, with a mono or polyphenolic material. Preferred examples of monophenolic materials which may be utilized include phenol, the cresols, p-tert-butylphenol, nonylphenol, octylphenol, other alkyl and phenyl substituted phenols. Preferred examples of polyphenolic materials include the various diphenols including bisphenol-A and bisphenol-F. Preferred aldehydes which may be utilized for the Novolac resin include formaldehyde, glyoxal, and the higher aldehydes up to about C₄. The preferred novolac resins typically are complex mixtures with different degrees of hydroxyl functionality.

Preferably, the Novolac resins can be prepared by the reaction of phenol or substituted phenol with an aldehyde, especially formaldehyde, in the presence of an acid or base. A preferred Novolac resin is a phenol-formaldehyde resin having a weight average molecular weight of 10,000 to 25,000 (e.g., Alnovol™ PN-320, available from Allnex GmbH).

### Additional Excipients

In various embodiments, the encapsulant system of the present disclosure further includes an additional excipient, which may be functional or non-functional monomeric compounds or polymeric compounds. Exemplary excipients are provided below. In various embodiments, the additional excipient may be present in an amount of about 5 wt. % to about 75 wt. %, based on the total weight of the composition. This concentration may refer to the collective amount of additional excipients or to individual additional excipients, if one or more additional excipients are present.

### Functional Compounds

Functional compounds according to the present disclosure preferably include various chemistries such as phenols, alkyl or aryl substituted carboxylic acids, sulfonic acids, phosphoric acids, phosphonic acids and boric acids.

Preferred phenolic compounds that can be used comprise at least one member selected from the group consisting of phenol or a substituted phenol (substituents include alkyl, aryl ether or amino groups or halogen atoms) for example p-tert-butylphenol, p-sec-butylphenol, o-tert-butylphenol, o-sec-butylphenol, p-tert-amylphenol, p-tert-octylphenol, p-nonylphenol, p-cumylphenol, p-dodecylphenol, styrylphenol, 2,6-di-tert-butylphenol, 2,4-di-tert-butylphenol, di-sec-butylphenol, 2,4-di-tert-amylphenol, 2,4-di-cumylphenol, o-cumyl-octylphenol, alpha-naphthol, beta-naphthol, bis-phenol A, bis-phenol F, bis-phenol TMC, and mixtures thereof.

Preferred carboxylic acids that can be used comprise at least one member selected from the group consisting of acetic acid, propanoic acid, hexanoic acid, 2-ethylhexanoic acid, decanoic acid, stearic acid, benzoic acid, salicylic acid, tall oil fatty acid (TOFA), dimer acid and mixtures thereof.

It is contemplated that various other acid functional compounds may be utilized in the compositions of the present disclosure. Non-limiting examples of such compounds include sulfonic acids e.g. p-toluene sulfonic acid, methane sulfonic acid, dodecylbenzene sulfonic acid, trifluoromethane sulfonic acid, phosphonic acid, phosphoric acid, boric acids etc.

### Functional Polymeric Compounds Include Various Chemistries Such as Polyesters, Acrylics, Polyethers, Polybutadienes, Polyamides, and Combination Thereof Etc.

As used herein, the term “functional” or “functionalized” refers to a compound or polymer which contains or has been modified to contain one or both of a carboxy and hydroxy group.

### Polyester Resins

Polyester resins are generally polycondensation products of polyalcohols and polycarboxylic acids. According to the disclosure a polyester resin is preferably the polycondensation product of polyalcohols and polycarboxylic acids, more preferably a polyester resin is the polycondensation product of dicarboxylic acids, di-alcohols (diols) and trifunctional alcohols or carboxylic acids.

The chemical structure of such polyester resins is represented below:

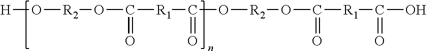

where:
   R₁=saturated or unsaturated alkyl or aryl,
   R₂=a C₁₋₁₀ alkyl or C₁₋₁₀ cycloalkyl, and
   n=0-20.

Preferred examples of polycarboxylic acids, especially dicarboxylic acids which may be used in the preparation of a polyester resin include isophthalic acid, terephthalic acid, hexahydroterephthalic acid, 2,6-naphthalenedicarboxylic acid, 4,4-oxybisbenzoic acid, 3,6-dichlorophthalic acid, tetrachlorophthalic acid, tetrahydrophthalic acid, hexahydroterephthalic acid, hexachloroendomethylenetetrahydrophthalic acid, endomethylenetetrahydrophthalic acid, phthalic acid, azelaic acid, sebacic acid, decanedicarboxylic acid, cyclohexanedicarboxylic acid, maleic acid, fumaric acid, adipic acid, succinic acid, and trimellitic acid. These polycarboxylic acids can be used in their acid form or in the form of their anhydrides, acyl chlorides or lower alkyl esters. Mixtures of polycarboxylic acids can also be used. In addition, hydroxycarboxylic acids and lactones can be used. Preferred examples include hydroxypivalic acid and ε-caprolactone. Monofunctional carboxylic acids may be used to block the polymer chain.

Polyalcohols, in particular diols, can be reacted with the carboxylic acids or their analogues as described above to prepare the polyester resin. Examples of polyalcohols include aliphatic diols, for example, ethylene glycol, propane-1,2-diol, propane-1,3-diol, butane-1,2-diol, butane-1,4-diol, butane-1,3-diol, 2,2-dimethylpropane-1,3-diol (neopentyl glycol), hexane-2,5-diol, hexane-1,6-diol, 2,2-bis-(4-hydroxycyclohexyl)-propane (hydrogenated bisphenol-A), 1,4-dimethylolcyclohexane, diethylene glycol, dipropylene glycol, 2,2-bis[4-(2-hydroxyethoxy)-phenyl]propane, the hydroxypivalic ester of neopentyl glycol, 4,8-bis-(hydroxymethyl) tricyclo[5,2,1,0]decane (=tricyclodecane dimethylol), and 2,3-butenediol.

Trifunctional or more functional alcohols or carboxylic acids can be used to obtain branched polyesters. Preferred examples of suitable trifunctional or more functional alcohols or carboxylic acids include but not limited to glycerol, hexanetriol, trimethylol ethane, trimethylol propane, pentaerythritol and sorbitol, trimellitic acid, trimellitic acid anhydride, pyromellitic acid, and dimethylolpropionic acid (DMPA).

The polyesters can be prepared via generally known polymerization methods such as conventional esterification and/or transesterification or by esterification and/or transesterification via the use of a catalyst. Useful catalysts include organo-tin compounds and organotitanium compounds. The polyester resin useful in the present invention can be hydroxy or carboxy functional. The conditions for preparing a polyester resin and the COOH/OH ratio can be chosen such that end products are obtained which have an acid value or hydroxyl value which is within the intended range of values. A polyester resin is classified as acid functional in case its hydroxyl value is lower than its acid value (AV). A resin is classified as hydroxy functional in case its acid value is lower than its hydroxyl value. The hydroxy functional resin should have a hydroxyl number from about >1 to 200, and the carboxy functional polyester should have an acid number from about >1 to about 200. The polyester compounds can be liquid, solids or a solution in organic solvent.

### Acrylic Resins

Preferably, the acrylic polymer useful in the invention can be prepared by free radical polymerization of acrylic and vinyl monomers with unsaturated monomers having hydroxy or carboxy groups. Preferred acrylic resins include those having a hydroxy functionality with a hydroxy number of from >1 to 200 and carboxy functionality having an acid number from >1 to 300. The preferred softening point of acrylic polymers is from about 50° C. to 200° C.

Preferred functional monomers are selected from acrylic acid, methacrylic acid, crotonic acid, hydroxyethyl acrylate, hydroxyethyl methacrylate, hydroxypropyl acrylate, and hydroxypropyl methacrylate. Other preferred acrylic monomers can be selected from the group consisting of the esters of an α,β-ethylenically unsaturated carboxylic acid having from 3 to 8 carbon atoms. A preferred acrylic monomer has the formula:

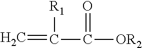

where:
   R₁ is H or methyl; and
   R₂ is C₁₋₈ alkyl.

Preferred acrylic monomers for the compositions of the present disclosure include: ethyl acrylate, butyl acrylate, isobutyl acrylate, 2-ethylhexyl acrylate, lauryl acrylate, methyl methacrylate, ethyl methacrylate, butyl methacrylate, isobutyl methacrylate, and lauryl methacrylate.

In various embodiments, the preferred acrylic polymer can optionally contain ethylenically monounsaturated vinyl comonomer which is different from the functional monomer and the acrylic monomer. Preferred examples of ethylenically unsaturated vinyl comonomers which can be useful are styrene, propylene, vinyl toluene, dimethyl styrene, alpha-methyl styrene, and vinyl acetate. The acrylics compounds can be liquid, solids or a solution is organic solvent.

Preferably, the copolymers can be prepared in any known manner, preferably by free-radical polymerization in bulk, solution, emulsion, or suspension. Preferably, the reaction is conducted in the presence of a free radical initiator such as benzoyl peroxide, tert-butyl peroxide, decanoyl peroxide, azo compounds such as azobisisobutyronitrile, and the like. Preferably, such initiators are present in amounts ranging from 0.1 to about 5 percent by weight of the total monomers.

In various embodiments, commercial examples of the acrylic resin used in the compositions of the present disclosure include ISOCRYL C-78 (sold by Estron Chemical Inc.), EPOMATT G-152 (sold by Estron Chemical Inc.) and JONCRYL 67 (sold by BASF).

### Polyether Resins

Preferred polyether resins to be used in the compositions of the present disclosure are polyalkylene glycols. Preferably, the polyalkylene glycols may have molecular weights of from 1,000 to 100,000 D [Dalton], preferably from 1,500 to 35,000 D, particularly preferably from 1,500 to 10,000 D. Particularly preferred polyalkylene glycols are polyethylene glycols. Furthermore, polypropylene glycols, polytetrahydrofurans or polybutylene glycols, which are obtained from 2-ethyloxirane or 2,3-dimethyloxirane, are also suitable. Other suitable polyethers are random or block copolymers of polyalkylene glycols obtained from ethylene oxide, propylene oxide and butylene oxides, such as, for example, polyethylene glycol-polypropylene glycol block copolymers. The block copolymers may be of the AB type or of the ABA type.

Further preferred polyalkylene glycols also include those which are alkylated at one terminal OH group or at both terminal OH groups. Suitable alkyl radicals are branched or straight-chain C₁- to C₂₂-alkyl radicals, preferably C₁-C₁₈-alkyl radicals, for example methyl, ethyl, n-butyl, isobutyl, pentyl, hexyl, octyl, nonyl, decyl, dodecyl, tridecyl or octadecyl radicals.

The preferred polyalkylene glycols also include those which are acid capped at one terminal OH group or at both terminal OH groups. Phosphonic acid-terminated polyethers are such an example of preferred polyalkylene glycols. Another example of preferred polyalkylene glycols are polyoxyethylene chains grafted on a polycarboxylate-type backbone.

Methods of making the polyether copolymers according to the present disclosure are generally known in the prior art. The preparation is effected by free radical polymerization, preferably in solution, in nonaqueous, organic solvents or in mixed nonaqueous/aqueous solvents. Suitable preparation processes are described, for example, in WO 2007/051743 and WO 2009/013202, the disclosure of which regarding the preparation process is hereby incorporated by reference in their entireties.

### Polybutadiene Resins

Preferred examples of the polybutadiene-based polyol resins for use in the compositions of the present invention include homopolymers such as 1,2-polybutadiene polyol and 1,4-polybutadiene polyol; copolymers such as poly(pentadiene·butadiene)polyol, poly(butadiene·styrene)polyol and poly(butadiene·acrylonitrile)polyol; and hydrogenated polybutadiene-based polyols obtained by hydrogenation of these polyol resins. These polybutadiene-based polyol resins are commercially available, for example, from Idemitsu Kosan Co., Ltd. as Poly bd R-15HT (hydroxyl value=102.7 mg KOH/mg, Mw1200) and Poly bd R-45HT (hydroxyl value=46.6 mg KOH/mg, Mw2800).

Also, the polybutadiene-based polyol resins preferably have a hydroxyl value of 40 to 330 mg KOH/g, more preferably 40 to 110 mg KOH/g, in terms of the advantages of the present disclosure. Also, the polybutadiene-based polyol resins preferably have a weight-average molecular weight (GPC) of 50 to 3,000, more preferably 800 to 1,500. Other preferred polybutadiene resin suitable for use in the compositions of the present disclosure include carboxylated polybutadiene, which may be in the form of a liquid polymer that is transparent at room temperature and has the polybutadiene backbone microstructure consisting of the combination of vinyl 1,2-linkage, trans 1,4-linkage and cis 1,4-linkage. The vinyl 1,2-linkage is preferably 30 wt % or less. The cis 1,4-linkage is preferably 40 wt % or more. The cis 1,4-linkage less than 40 wt % can lead to decreased adhesion of the resulting composition and is thus undesirable.

The carboxylated polybutadiene component can be obtained by reacting a carboxyl group-introducing compound with a liquid polybutadiene. 1,3-butadiene that composes the liquid polybutadiene and the carboxyl group-introducing compound are preferably used in respective proportions of 80 to 98% by mass (1,3-butadiene) and 2 to 20% by mass (carboxyl group-introducing compound).

The liquid polybutadiene used in the reaction preferably has a number average molecular weight of 500 to 10,000, and more preferably 1,000 to 7,000. The liquid polybutadiene desirably has a wide distribution of the molecular weight. More preferably, the liquid polybutadiene has an iodine value 30 to 500 g iodine/100 g of the material as determined according to DIN53241. Preferably, the liquid polybutadiene has a molecular structure that is composed of 70 to 90% of cis double bonds, 10 to 30% of trans double bonds and 0 to 3% of vinyl double bonds.

Preferred examples of the carboxyl group-introducing compounds that can be used include ethylene-based unsaturated dicarboxylic compound, such as ethylene-based unsaturated dicarboxylic acids and anhydrides or monoesters thereof. Specific examples of the compounds include maleic acid, fumaric acid, itaconic acid, 3,6-tetrahydrophthalic acid, itaconic anhydride, 1,2-dimethylmaleic anhydride, maleic acid monomethyl ester or maleic acid monoethyl ester. Of these, maleic anhydride is preferred because of its safety, economy and reactivity (maleic polybutadiene is preferred).

Methods for creating the polybutadiene/maleic anhydride adduct are generally known in the prior art.

The maleic liquid polybutadiene preferably has an acid value of 50 to 120 (mg KOH/g), and more preferably 70 to 90 (mg KOH/g), as determined according to DIN ISO 3682. An acid value less than 50 (mg KOH/g) results in decreased adhesion of the resulting composition, whereas an acid value greater than 120 (mg KOH/g) leads to increased viscosity of the resulting composition, making the composition less workable. The maleic percentage of the maleic liquid polybutadiene is preferably 6 to 20%, more preferably 6 to 15%, and even more preferably 7 to 10% although it needs to be taken into account along with the viscosity.

The viscosity of the maleic liquid polybutadiene (at 20° C.) as determined by DIN 53214 is preferably from 3 to 16 Pa-s, more preferably from 5 to 13 Pa-s, and even more preferably from 6 to 9 Pa-s.

Further, the maleic liquid polybutadiene contains 30% or less of vinyl double bonds. A liquid polybutadiene in which cis double bonds are present within the above-specified range tends to have a higher flexibility and a higher maleic percentage (i.e., acid value) as described above as compared to a liquid polybutadiene in which the cis double bonds are present at a lower percentage than the above-specified lower limit. As a result, the composition will have a high adhesion and a sufficient polarity imparted thereto, making it possible to make a more flexible composition and to readily adjust the flexibility of the composition of the present disclosure. Further, the resulting composition has improved decorativeness.

While the viscosity of a liquid polybutadiene in which the cis double bonds are present at a lower percentage than the above-specified lower limit rapidly increases with increasing maleic percentage, the viscosity of a liquid polybutadiene having cis double bonds within the above-specified range exhibits only a small increase. The low viscosity within the above-specified range ensures high reactivity and improves workability. Also, the resulting composition has improved decorativeness.

Non-limiting examples of a polybutadiene resin according to the present disclosure is a maleic anhydride adduct of cis-1.4-polybutadiene (e.g., low molecular weight cis-1.4-polybutadiene), optionally having succinic anhydride pendant groups randomly distributed the polymer chain. Examples of such polybutadiene resins include POLYVEST OC 800S, POLYVEST OC 1200S, and POLYVEST MA-75, each of which are manufactured by Evonik Industries.

### Polyamide Resins

Polyamides are typically condensation copolymers formed by reaction of dicarboxylic acids with diamines or by ring opening of lactams. Various polyamides can be created by adjusting the number of carbons. The nomenclature used herein designates the number of carbon atom in the diamine first and the number of carbons atoms in the diacid second. Therefore, Polyamide-6,6 has six carbons from the diamine, and six carbons from the diacid, and Polyamide-6,12 would have six carbons from the diamine and twelve carbons from the diacid. Polyamide-6 is a homopolymer formed by a ring-opening polymerization (i.e. ring-opening polymerization of caprolactam). The polyamide may also be nylon-9, nylon-12, nylon-11, nylon 4,6, nylon 6,10, or any of the polyamides listed herein.

The polyamide resins useful in the compositions of the present disclosure include nylon-6, nylon 6-6, a copolymer of nylon-6 and nylon 6-6, nylon-9, nylon-10, nylon-11, nylon-12, nylon 6-10, aromatic polyamides, elastomeric polyamides, and mixtures thereof.

The conditions for preparing a polyamide resin and the COOH/NH₂ ratio can be chosen such that end products are obtained which have an acid value or amine value which is within the intended range of values. A polyamide resin is classified as acid functional in case its amine value is lower than its acid value (AV). A resin is classified as amine functional in case its acid value is lower than its amine value. Evonik's Ancatherm 592 is an example of acid functional thermoplastic polyamide.

### Non-Functional Polymeric Compounds

Non-functional polymeric compounds useful for the compositions of the present disclosure include polyimides, styrene-butadiene resins as well as copolymers of other olefins and combination thereof.

Preferred examples of non-functional resin compounds that can be used in the present disclosure in combination with phenolic resins include compounds from Evonik's POLYVEST liquid polybutadienes product line, thermoplastic acrylic resins and MBS polymers from Dow's Paraloid product line, non-functional polyamides from Evonik's Vestamid product line, styrenic block copolymers (SBC) from Kraton made from butadiene, styrene and isoprene raw materials and finally, ketone-aldehyde condensation resins such as Evonik's TEGO Variplus AP can also be used in the present disclosure in combination with polyphenols.

### Curable Epoxy Resins

Every aspect and every embodiment of the invention as disclosed herein is intended to be combined with all the other disclosed aspects and embodiments of the invention individually and in all possible combinations thereof.

The solutions of urea compounds with phenolic resins and/or the other resins and combinations described above are used as curing agents for epoxy resins. Epoxy resins commercially available under the trade name DER 383 or DER 333 (available from Dow) and EPON 826 or EPON 828 (available from Hexion Specialty Chemicals) are suitable for use with the latent curing accelerator compositions of the present disclosure.

Other epoxy resins may include, but are not limited to, bi-functional epoxies, such as, bisphenol-A and bisphenol-F resins. Multifunctional epoxy resin, as utilized herein, describes compounds containing two or more 1,2-epoxy groups per molecule. Epoxide compounds of this type are well known to those of skill in the art and are described in Y. Tanaka, “Synthesis and Characteristics of Epoxides,” in C. A. May, ed., Epoxy Resins Chemistry and Technology (Marcel Dekker, 1988), which is incorporated herein by reference.

One class of epoxy resins suitable for use in the present disclosure comprises the glycidyl ethers of polyhydric phenols, including the glycidyl ethers of dihydric phenols. Illustrative examples include, but are not limited to, the glycidyl ethers of resorcinol, hydroquinone, bis-(4-hydroxy-3,5-difluorophenyl)-methane, 1,1-bis-(4-hydroxyphenyl)-ethane, 2,2-bis-(4-hydroxy-3-methylphenyl)-propane, 2,2-bis-(4-hydroxy-3,5-dichlorophenyl) propane, 2,2-bis-(4-hydroxyphenyl)-propane (commercially known as bisphenol A), bis-(4-hydroxyphenyl)-methane (commercially known as bisphenol-F, and which may contain varying amounts of 2-hydroxyphenyl isomers), and the like, or any combination thereof. Additionally, advanced dihydric phenols of the following structure also are useful in the present disclosure:

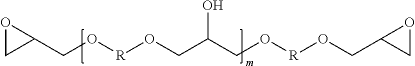

where m is an integer and R is a divalent hydrocarbon radical of a dihydric phenol, such as those dihydric phenols listed above.

Materials according to this formula can be prepared by polymerizing mixtures of a dihydric phenol and epichlorohydrin, or by advancing a mixture of a diglycidyl ether of the dihydric phenol and the dihydric phenol. While in any given molecule the value of m is an integer, the materials are invariably mixtures which can be characterized by an average value of m which is not necessarily a whole number. Polymeric materials with an average value of m between 0 and about 7 can be used in one aspect of the present disclosure. In other embodiments, the epoxy component may be a polyglycidyl amine from one or more of 2,2′-methylene dianiline, m-xylene dianiline, hydantoin, and isocyanate.

The epoxy component may be a cycloaliphatic (alicyclic) epoxide. Examples of suitable cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, vinylcyclohexene diepoxides; limonene diepoxide; bis(3,4-epoxycyclohexylmethyl)pimelate; dicyclopentadiene diepoxide; and other suitable cycloaliphatic epoxides. Other suitable diepoxides of cycloaliphatic esters of dicarboxylic acids are described, for example, in WO 2009/089145 A1, which is hereby incorporated by reference.

Other cycloaliphatic epoxides include 3,3-epoxycyclohexylmethyl-3,4-epoxycyclohexane carboxylate such as 3,4-epoxycyclohexylmethyl-3,4-epoxycyclohexane carboxylate; 3,3-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexyl-methyl-3,4-epoxy-3-methylcyclohexane carboxylate. Other suitable 3,4-epoxycyclohexylmentyl-3,4-epoxycyclohexane carboxylates are described, for example, in U.S. Pat. No. 2,890,194, which is hereby incorporated by reference. In other embodiments, the epoxy component may include polyol polyglycidyl ether from polyethylene glycol, polypropylene glycol or polytetrahydrofuran or combinations thereof.

Resins 1 and 2 are reacted with the urea compounds under nitrogen at elevated temperatures of 120 to 180° C. A sufficient amount of the resins is reacted to block substantially all of the tertiary amine functionalities in the urea composition. As a general rule, about 25 wt % to 100 wt % resin, based on urea compounds, is added to and reacted with the urea composition. If not enough phenol resin 1 is added, the resulting product is sticky and clumps. If too much is added, the activation temperature to cure the epoxy resin becomes too high. After one hour reacting time, the hot solution is poured onto a Teflon block or aluminum sheet and allowed to cool to room temperature. The resins can be added into the reactor either neat as described above or dissolved in some type of polar solvent such as methanol. In the latter case, the resulting reaction mixture is refluxed for two hours to form a clear solution. The mixture is then cooled to room temperature and the solvent is removed by evaporation. The resulting product is further dried under vacuum.

Once collected from the reactor, the final curing agent formulation is ground to a fine powder using spray drying, milling with ceramic beads, jet milling, coffee grinding, etc. Particle size of the powder can range between 1 micron to 100 microns. The powder is then incorporated into the epoxy resin and mixed using a speed mixer, Cowles blade mixer or planetary mixer, etc. Optional additives such as wetting agents, fillers, defoamers, rheology modifiers, etc. can be added if necessary.

In one aspect of the invention, the urea-(resin 1:resin 2) compound reaction products can be used as epoxy curing agents in one-component and two-component epoxy compositions such as adhesives and composites, decorative and protective coatings including powder coatings, coatings on concrete, wood, metal etc., filament winding, printed circuit board, electrical potting and encapsulation, cured in place pipe, crash durable adhesives, transfer molding powders, prepreg with solid or liquid epoxy, sheet molding compound, resin transfer molding, EV battery pack adhesives and like epoxy applications. Typically, 0.5 to 10 parts by weight (pbw) urea-(resin 1:resin 2) compound reaction products are used in the epoxy composition per 100 pbw epoxy resin, preferably 2 to 6 pbw of urea-(resin 1:resin 2) compound reaction products.

In another aspect of the invention, the urea-(resin 1:resin 2) compound reaction products can also be used as accelerators for curing agents, such as dicyandiamide, Mercaptan and acid anhydrides like acetic anhydride, in one-component and two-component epoxy compositions such as adhesives and composites, decorative and protective coatings including powder coatings, coatings on concrete, wood, metal etc., filament winding, printed circuit board, electrical potting and encapsulation, cured in place pipe, crash durable adhesives, transfer molding powders, prepreg with solid or liquid epoxy, sheet molding compound, resin transfer molding, EV battery pack adhesives and like epoxy applications. Typically, 0.5 to 10 parts by weight (pbw) curing agent are used in the epoxy composition per 100 pbw epoxy resin, preferably 2 to 6 pbw of curing agent, and 0.5 to 10 parts by weight (pbw) urea-(resin 1:resin 2) compound reaction products are used as an accelerator in the epoxy composition per 100 pbw epoxy resin, preferably 2 to 6 pbw of urea-(resin 1:resin 2) compound reaction products.

The urea-(resin 1:resin 2) compound reaction product as a curing agent or as an accelerator with the a curing agent is combined with an epoxy resin which is a polyepoxy compound containing more than one 1,2-epoxy groups per molecule. Such epoxides are well known in the epoxy art and are described in Y. Tanaka, “Synthesis and Characteristics of Epoxides”, in C. A. May, ed., Epoxy Resins Chemistry and Technology (Marcel Dekker, 1988). Examples include those epoxides disclosed in U.S. Pat. No. 5,599,855 (Col 5/6 to 6/20), which is incorporated by reference. The preferred polyepoxy compounds are the diglycidyl ethers of bisphenol-A, the advanced diglycidyl ethers of bisphenol-A, the diglycidyl ethers of bisphenol-F, and the epoxy Novolac resins. Both liquid epoxy resins and solid epoxy resins are suitably used in the one component epoxy compositions. Powder coating compositions would comprise a solid epoxy resin, a urea compound and dicyandiamide.

In one aspect of the invention the one-component epoxy resin composition comprises the contact product of such urea-(resin 1:resin 2) compound reaction product as a curing agent, with epoxy resin. In another aspect of the invention the one-component epoxy resin composition comprises the contact product of dicyandiamide, Mercaptan or an acid anhydride as a latent curing agent, such urea-(resin 1:resin 2) compound reaction product as an accelerator for the curing agent with an epoxy resin.

In another aspect of the invention the one-component 100% solids epoxy compositions comprising a urea-(resin 1:resin 2) compound reaction product, a latent curing agent, such as dicyandiamide, Mercaptan or acid anhydride, and an epoxy resin which offer low-temperature cure and shelf stability, i.e., longer latency.

In another aspect of the invention the one-component water based epoxy compositions comprising a urea-(resin 1:resin 2) compound reaction product, a latent curing agent, such as dicyandiamide, Mercaptan or acid anhydride, and an epoxy resin which offer low-temperature cure and shelf stability, i.e., longer latency.

In another aspect of the invention the one-component 100% solids epoxy compositions comprising a urea-(resin 1:resin 2) compound reaction product as a latent curing agent, optionally an accelerator, and an epoxy resin which offer low-temperature cure and shelf stability, i.e., longer latency.

In another aspect of the invention the one-component water based epoxy compositions comprising a urea-(resin 1:resin 2) compound reaction product as a latent curing agent, optionally an accelerator, and an epoxy resin which offer low-temperature cure and shelf stability, i.e., longer latency.

The urea-(resin 1:resin 2) compound reaction product of the invention have been found to cure epoxy resin compositions at low temperature and can be used as the sole curing agent or as an accelerator for latent curing agents such as dicyandiamide (DICY), Mercaptan or acid anhydrides in one-component epoxy resin compositions.

Epoxy compositions containing the urea-(resin 1:resin 2) compound reaction products as sole curing agents or accelerators can afford long pot-life, low activation temperature, good glass transition temperature, or a combination of these attributes.

The term “contact product” is used herein to describe compositions wherein the components are contacted together in any order, in any manner, and for any length of time. For example, the components can be contacted by blending or mixing. Further, contacting of any component can occur in the presence or absence of any other component of the compositions described herein. In addition, in contacting the components together two or more of the components may react to form other components.

Epoxy compositions comprising urea-(resin 1:resin 2) compound reaction products and epoxy resins can be formulated with a wide variety of ingredients well known to those skilled in the art of coating formulation, including solvents, fillers, pigments, pigment dispersing agents, rheology modifiers, thixotropes, flow and leveling aids, and defoamers.

While one component epoxy compositions comprising 1 to 90 wt % organic solvents, or 100 wt % solids epoxy compositions, or water-based, i.e., aqueous, epoxy compositions containing 20 to 80 wt % solids can be used, it is preferred the epoxy composition be 100 wt % solids.

The epoxy compositions of this invention can be applied as coatings by any number of techniques including spray, brush, roller, paint mitt, and the like. Numerous substrates are suitable for application of coatings of this invention with proper surface preparation, as is well understood in the art. Such substrates include but are not limited to many types of metal, particularly steel and aluminum, as well as concrete.

One component epoxy compositions of this invention can be cured at elevated temperatures ranging from about 80° C. to about 240° C., with cure temperatures of 120° C. to 160° C. preferred. Two component epoxy compositions of this invention can be cured at temperatures ranging from about 80° C. to about 240° C., with cure temperatures of 80° C. to 160° C. preferred.

### EXAMPLES

### Example 1

208 g of N′-(3-dimethylaminopropyl)-N,N-dimethyl-propane-1,3-diamine were charged to a 1-L four-neck glass vessel equipped with mechanical stirrer, thermocouple, electric heating mantle, addition funnel, reflux condenser and a nitrogen purge. The vessel was heated to 60-70° C. under nitrogen. Once the temperature stabilized, 127 g of toluene diisocyanate monomer was metered in slowly via the addition funnel over 45-60 minutes. The mixture was held at 60-80° C. for one hour after the addition was completed. The temperature was raised to 150° C. and 82.5 g of Isocryl C-78 acrylic resin together with 82.5 g of Alnovol PN320 phenolic resin were added over a 60-90 min period. On completion of the addition, the mixture was kept at 150° C. with stirring for an additional hour. The product was poured from the reactor at that temperature and allowed to cool to ambient before grinding the product.

### Example 2

208 g of N′-(3-dimethylaminopropyl)-N,N-dimethyl-propane-1,3-diamine were charged to a 1-L four-neck glass vessel equipped with mechanical stirrer, thermocouple, electric heating mantle, addition funnel, reflux condenser and a nitrogen purge. The vessel was heated to 60-70° C. under nitrogen. Once the temperature stabilized, 127 g of toluene diisocyanate monomer was metered in slowly via the addition funnel over 45-60 minutes. The mixture was held at 60-80° C. for one hour after the addition was completed. The temperature was raised to 150° C. and 82.5 g of Epomatt G-152 acrylic resin together with 82.5 g of Alnovol PN320 phenolic resin were added over a 60-90 min period. On completion of the addition, the mixture was kept at 150° C. with stirring for an additional hour. The product was poured from the reactor at that temperature and allowed to cool to ambient before grinding the product.

### Example 3

208 g of N′-(3-dimethylaminopropyl)-N,N-dimethyl-propane-1,3-diamine were charged to a 1-L four-neck glass vessel equipped with mechanical stirrer, thermocouple, electric heating mantle, addition funnel, reflux condenser and a nitrogen purge. The vessel was heated to 60-70° C. under nitrogen. Once the temperature stabilized, 127 g of toluene diisocyanate monomer was metered in slowly via the addition funnel over 45-60 minutes. The mixture was held at 60-80° C. for one hour after the addition was completed. The temperature was raised to 150° C. and 33 g of Joncryl 67 acrylic resin together with 132 g of Alnovol PN320 phenolic resin were added over a 60-90 min period. On completion of the addition, the mixture was kept at 150° C. with stirring for an additional hour. The product was poured from the reactor at that temperature and allowed to cool to ambient before grinding the product.

### Example 4

A mixture of 220.3 g of N′-(3-dimethylaminopropyl)-N,N-dimethyl-propane-1,3-diamine and 50 g of toluene were charged to a one liter four-neck glass vessel equipped with an air driven mechanical stirrer, thermocouple, heating jacket with a water circulating bath and a nitrogen purge. The vessel was heated to 60-70° C. under nitrogen. Once the temperature stabilized, 104.9 g of toluene diisocyanate in 50 g of toluene was metered in over 45-60 minutes. The mixture was held at 70° C. for one hour after the addition was completed. The temperature was lowered to 40° C. and the reactor crude liquid product was placed on a rotary evaporator to remove all of the toluene. Temperature and vacuum was applied slowly to prevent frothing. The final conditions for the distillation were a 15 minute hold at 10-20 mmHg and 80° C. The stripped product was then placed in a three neck flask equipped with a mechanical stirrer, thermocouple, electric heating mantle and a nitrogen purge. The vessel was stabilized at 140-160° C. and 174.8 g of phenolic resin was added over a 30-60 min period. The mixture was kept at 160° C. with stilling for an additional hour. The product was poured from the reactor at that and allowed to cool to ambient before grinding the product.

### Example 5—Differential Scanning Calorimetry (DSC) of Resin-Blocked Urea Curatives

Reaction products of Examples 1-4 were screened by differential scanning calorimeter (DSC) for their cure profile as epoxy curing agents. The epoxy formulation comprised polyglycidyl ether of Bisphenol A resin (Epon 828), 2 phr (wt parts per 100 wt parts resin) of Examples 1-4 as the accelerator, 6 phr of dicyandiamide as the curing agent and 2 wt. % fumed silica. The resulting mixtures were blended thoroughly for 2 minutes using a speed mixer. Immediately after preparation the mixtures were analyzed by DSC (TA instruments QA20) to determine the onset cure temperature, heat of reaction (□H) and glass transition temperature (Tg). The DSC was operated in accordance with standard methods using software included in the DSC. The DSC analysis was performed using a 10° C./min ramp heat rate on about a 10 to 15 mg sample of material. The resulting data is presented in Table 1 below.

TABLE 1

| | Onset | | |
|---|---|---|---|
| Accelerator/DICY/silica/EPON828 | temp. | ΔH | Tg |
| 2/6/2/100 parts per weight | (° C.) | (J/g) | (° C.) |
| Example 1 | 135.4 | 450.9 | 123.6 |
| Example 2 | 143.3 | 432.1 | 127.4 |
| Example 3 | 142.0 | 455.1 | 124.7 |
| Example 4 | 146.0 | 470.3 | 125.9 |

### Example 6: Latency of Resin-Blocked Urea Curatives

The latency of Examples 1-4 as an accelerator for DICY was studied at 40° C. using an epoxy formulation that comprised polyglycidyl ether of Bisphenol A resin (Epon 828), 2 phr of the accelerator, 6 phr of dicyandiamide as the curing agent and 2 wt. % fumed silica. Latency was monitored as viscosity change upon aging at 40° C. by a Brookfield Cone and Plate viscometer (model HADV II+CP) with a #52 spindle at 25° C. using 0.5 mL sample. Shelf stability was determined by visual observation to determine gelation time. Fresh epoxy samples were blended thoroughly for 2 minutes using a speed mixer, cooled to 25° C. and the initial viscosity was measured using a cone and plate Brookfield viscometer. The samples were stored in 40° C. oven, cooled to 25° C. and the viscosity changes were measured over time. The resulting data is presented in Table 2.

TABLE 2

| | Initial | % Visc. |
|---|---|---|
| Accelerator/DICY/silica/EPON828 | Viscosity, | Increase after |
| 2/6/2/100 parts per weight | cP | 4 weeks@40° C. |
| Example 1 | 20,160 | 35.86% |
| Example 2 | 19,450 | 36.71% |
| Example 3 | 19,730 | 54.54% |
| Example 4 | 20,840 | 26.01% |

### Example 7: Adhesion Properties

The adhesion properties of the resin-blocked urea curatives were measured by the Lap Shear and T-Peel techniques. The Lap shear measurements were conducted on an Instron Model 1125 instrument according to the Lap Shear ASTM method D1876 with at least five replicates. The test materials were applied to a 1″×04″λ0.32″ cold rolled steel panel (ACT Cold Roll Steel 01X04X032 B952 P60 DIW: Unpolished). The materials were applied with 10 mil glass beads (1% based on formulation weight) to ½″ ends of the coupon. Another coupon was laid on top overlapping the ½″ bands on the other coupon. The panels with test materials were cured for 15-30 min at temperatures between 130° C. and 160° C., and then, let cool down to room temperature before measurement.

The T-peel measurement was conducted on an Instron Model 1125 instrument according to the Lap Shear ASTM method D1876 with at least five replicates. The test materials were applied to a 1″×4″×0.32″ cold rolled steel panel (ACT Cold Roll Steel 01X04X032 B952 P60 DIW: Unpolished) pre-bent at right angle at ⅞″ from the end, leaving 3⅛″×1″ surface. The materials were applied with 10 mil glass beads (1% based on formulation weight). The test materials were cured for 15-30 min at temperatures between 130° C. and 160° C., and then, let cool down to room temperature before measurement. The results of the Lap Shear and T-Peel measurements are shown in Table 3 below:

TABLE 3

| Accelerator/DICY/silica/EPON828 | Lap | T-Peel |
|---|---|---|
| 2/6/2/100 parts per weight | Shear (psi) | (pli) |
| Example 1 | 952 | 118 |
| Example 2 | 755 | 67 |
| Example 3 | 880 | 108 |
| Example 4 | 411 | 66 |

While the invention has been described with reference to certain aspects or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular aspect or embodiment disclosed as the best mode contemplated for carrying out this invention, but that the invention will include all embodiments falling within the scope of the appended claims including using the aspects or embodiments of the invention alone or in combination with each other.

1. A latent curing accelerator composition comprising:
an encapsulant system comprising:
a urea compound,
a polyphenol resin, and
an additional excipient selected from a functional component and/or a non-functional component.

2. The composition according to claim 1, wherein the polyphenol resin is a phenolic novolac resin.

3. The composition according to claim 2, wherein the phenolic novolac resin is a phenol-formaldehyde resin.

4. A latent curing accelerator composition comprising:
an encapsulant system comprising:
a urea compound, and
an additional excipient selected from a functional component and/or a non-functional component.

5. The composition according to any of the preceding claims, wherein the urea compound comprises a reaction product of an isocyanate and an alkylated polyalkylenepolyamine.

6. The composition according to any of the preceding claims, wherein the isocyanate is selected from the group consisting of aliphatic isocyanates, cycloaliphatic isocyanates and aromatic isocyanates.

7. The composition according to claim 6, wherein the isocyanate is selected from the group consisting of phenylisocyanate, toluene diisocyanate (TDI), methylene diphenyl diisocyanate (MDI) and polymeric methylene diphenyl diisocyanate.

8. The composition according to any of claims 5-7, wherein the alkylated polyalkylenepolyamine has at least one primary or secondary amine and at least two tertiary amines of the formula (A): 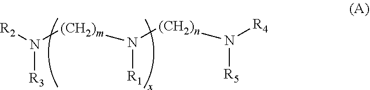
where R₁, R₂, R₃, R₄ and R₅ are independently hydrogen, methyl or ethyl; m and n are independently integers from 1 to 6 and; X is an integer from 1 to 10.

9. The composition according to claim 8, wherein R₁ is hydrogen or methyl; R₂ and R₄ are methyl; and R₃ and R₅ are hydrogen or methyl.

10. The composition according to any of the preceding claims, wherein the additional excipient is a functional polymeric compound.

11. The composition according to any of the preceding claims, wherein the additional excipient is selected from a polyamide resin, a polybutadiene resin, a polyester resin, a polyether resin, and an acrylic resin.

12. The composition according to any of the preceding claims, wherein the additional excipient is an acrylic resin.

13. The composition according to any of the preceding claims, which is combined with an epoxy resin to form a curable epoxy system, wherein the curable epoxy system does not gel after 4 weeks under accelerated aging conditions (i.e., storage for 4 weeks at 40° C.).

14. The composition according to any of the preceding claims, which is combined with an epoxy resin to form a curable epoxy system, wherein the curable epoxy system gives a lap shear greater than 700 psi.

15. A method for curing a substance through use of a latent curing accelerator composition according to any of the preceding claims, the method comprising the step of combining the substance with the latent curing accelerator composition and heating the resulting mixture.

16. The method according to claim 15, wherein the substance is an epoxy resin.

17. The method according to claim 15 or 16, wherein the composition is a latent curing agent (e.g., the sole latent curing agent) for an epoxy resin, or wherein the composition is used as an accelerator for a curing agent such as DICY or an acid anhydride for epoxy resin.

18. The method according to any of claims 15-17, wherein the composition is used as a latent curing accelerator for structural adhesives and composites, electrical potting and encapsulation, compositions for reinforcement and/or dampening, cured in place pipe, crash durable adhesives, filament winding, transfer molding powders, prepreg with solid or liquid epoxy, sheet molding compound, coatings on concrete, wood, metal etc., resin transfer molding, and/or EV battery pack adhesives.
